(19) United States
(12) Patent Application Publication
(10) Pub. No.: US 2009/0012817 A1
(43) Pub. Date: Jan. 8, 2009

(54) SYSTEM AND METHOD FOR FACILITATING CROSS ENTERPRISE DATA SHARING IN A HEALTHCARE SETTING

(76) Inventors: Charles S. Squires, Madison, WI (US); Khiang Seow, Fitchburg, WI (US); David E. Fuhmann, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 11/774,252

(22) Filed: Jul. 6, 2007

Related U.S. Application Data
(62) Division of application No. 11/813,440.

(51) Int. Cl. G06Q 50/00; G06F 17/30

(52) U.S. Cl. 705/3

(57) ABSTRACT

A method and system for sharing charts associated with a first patient among system entities within a networked system wherein different entities maintain different charts for the first patient, the method comprising the steps of at each of at least a subset of the entities and for the first patient, when a chart is generated, generating a release authorization (RA) token for the chart, maintaining an RA token list including all of tokens received for the first patient from any other system entities, when a token is received from another entity, using the received token to access a chart associated with the received token that is stored at another entity and when a requesting entity requests a chart associated with the first patient, providing the chart along with the RA token list associated with the first patient to the requesting entity.

### CROSS-REFERENCE TO RELATED APPLICATIONS

This application is a continuation in part of U.S. patent application Ser. No. 11/813,440 which was filed on Jul. 6, 2007 and which has the same title as this application and claims benefit of the following U.S. Provisional Applications: Ser. No. 60/655,733, entitled “System And Method For Facilitating Cross Enterprises Data Sharing In A Healthcare Setting” filed Feb. 24, 2005 (attorney docket no. 29794/41011), and Ser. No. 60/660,390, entitled “System And Method For Facilitating Cross Enterprises Data Sharing In A Healthcare Setting” filed Mar. 10, 2005 (attorney docket no. 29794/41011A), the disclosures of which are hereby expressly incorporated herein by reference.

### TECHNICAL FIELD

This patent relates generally to health record management, and more particularly, this patent relates to a system and method for facilitating cross enterprises data sharing of healthcare information.

### BACKGROUND

At least some inventive embodiments include a method for sharing related charts among entities comprising the steps of at a first entity, creating a first chart associated with a first patient and a first release authorization (RA) token associated with the first chart, maintaining a first token list including at least a second RA token associated with a second chart maintained by a second entity, at a third entity, receiving the first RA token, using the first RA token to request the first chart from the first entity, at the first entity, receiving the request for the first chart, rendering the first chart accessible to the third entity, providing the first token list to the third entity and at the third entity, receiving the first token list and using the second RA token on the first token list to request the second chart from the second entity.

In some cases the method further includes the steps of, at the second entity, receiving the request for the second chart and rendering the second chart accessible to the third entity. In some cases the method further includes the steps of generating a third chart at the third entity, generating a third RA token at the third entity, presenting the third RA token to each of the first and the second entities and storing the third RA token in the first token list and in a second token list at the first and second entities, respectively. In some cases the method further includes the step of, at the third entity, maintaining a third token list for the first patient that includes each token received by the third entity.

In other cases the method further includes the steps of, at the third entity, when the first token list is received, using each of the RA tokens on the first token list to request an associated chart and, at each entity that receives a request, rendering a chart accessible to the third entity. In some cases the method further includes the steps of generating a third chart at the third entity, generating a third RA token at the third entity, presenting the third RA token to each of the first and the second entities and storing the third RA token in the first token list and in a second token list at the first and second entities, respectively.

In other cases the method further includes the step of, at the third entity, maintaining a third token list for the first patient that includes each token received by the third entity. In other cases the method further includes the steps of generating a third chart at the third entity, generating a third RA token at the third entity, presenting the third token to the first entity and storing the third token in the first token list at the first entity.

In some embodiments the step of rendering the first chart accessible includes transmitting the first chart to the third entity and wherein the step of receiving the first RA token includes transmitting the first RA token to the third entity. In other cases the method further includes the steps of generating a third chart at the third entity, storing each RA token received at the third chart in a third token list and when a requesting entity requests the third chart from the third entity, providing the third token list to the requesting entity along with the third chart.

It will be appreciated that the invention has applications in other areas beyond healthcare records, where security of access to personal sensitive data is an issue. For example, personal financial information (lists of bank accounts and access to them, share portfolio access, pension fund review access, personal utility bill accounts, etc.) accessed by financial advisors/accountants/attorneys/or other disciplines may need access to a range of sensitive personal data kept on the servers of different entities. Access to sensitive results/information held in different entities could also extend to physical/national security issues and the police or government agencies may have a need to have an audit trail of access to criminal records, the existence and location of weapons, and their current states, nuclear plants and radioactive materials: all sensitive. The invention would find application in areas beyond patient information, but we are choosing to limit the protection we are seeking to that area to enhance intelligibility of the patent application.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

In some cases each entity that receives a token associated with a chart maintained by another system entity stores the token in a token list and provides the token list to other entities that request an associated chart maintained by the entity. In some cases the first entity is a primary care physician entity for the first patient and wherein the second entity stores a primary care token associated with the first entity and the first patient and wherein, when the third entity uses the second RA token to request the second chart, the second entity provides the second chart and the Primary care token to the requesting entity.

Other embodiments include a method for sharing charts associated with a first patient among system entities within a networked system wherein different entities maintain different charts for the first patient, the method comprising the steps of at each of at least a subset of the entities and for the first patient, when a chart is generated, generating a release authorization (RA) token for the chart, maintaining an RA token list including all of tokens received for the first patient from any other system entities, when a token is received from another entity, using the received token to access a chart associated with the received token that is stored at another entity and when a requesting entity requests a chart associated with the first patient, providing the chart along with the RA token list associated with the first patient to the requesting entity.

In other cases the method further includes the steps of, when a chart is generated by an entity, the token generated by the chart is provided to each of the entities associated with RA tokens in the RA token list maintained by the entity.

Other embodiments include a system for sharing related charts among entities comprising first and third entities including processors that run programs to perform the steps of at the first entity, creating a first chart associated with a first patient and a first release authorization (RA) token associated with the first chart, maintaining a first token list including at least a second RA token associated with a second chart maintained by a second entity, at a third entity, receiving the first RA token, using the first RA token to request the first chart from the first entity, at the first entity, receiving the request for the first chart, rendering the first chart accessible to the third entity, providing the first token list to the third entity and at the third entity, receiving the first token list and using the second RA token on the first token list to request the second chart from the second entity.

In some cases the second entity includes a processor that runs programs to perform the steps of receiving the request for the second chart and rendering the second chart accessible to the third entity. In some cases the third entity processor is further programmed to generate a third chart at the third entity, generate a third RA token at the third entity and present the third RA token to each of the first and the second entities and wherein the first and second entity processor are further programmed to store the third RA token in the first token list and in a second token list at the first and second entities, respectively. In some cases the third entity processor is further programmed to maintain a third token list for the first patient that includes each token received by the third entity. In some cases the third entity processor is further programmed to, when the first token list is received, use each of the RA tokens on the first token list to request an associated chart. In some cases the first entity renders the first chart accessible by transmitting the first chart to the third entity.

Other embodiments include a method for sharing charts associated with a first patient among system entities within a networked system wherein different entities maintain different charts for the first patient, the method comprising the steps of at each of at least a subset of the entities and for the first patient, when a chart is generated, generating a release authorization (RA) token for the chart, maintaining an RA token list including all of the tokens received for the first patient from any other system entities, when the generated RA token is presented to a receiving entity, presenting at least a subset of the other tokens from the token list to the receiving entity and when the entity receives a token, using each received token to obtain an associated chart stored by another entity.

### BRIEF DESCRIPTION OF THE DRAWINGS

FIG. 1 is an embodiment of an exemplary system to provide a data sharing architecture that allows healthcare information systems to share and exchange information;

FIG. 2 is an alternative embodiment of an exemplary system to provide a data sharing architecture that allows healthcare information systems to share and exchange information;

FIG. 3 is an alternative embodiment of an exemplary system to provide a data sharing architecture that allows a healthcare information system to share and exchange information;

FIG. 4 is an exemplary schematic diagram of several system components located in an enterprise;

FIG. 5 is a block diagram an integrated patient/provider electronic medical record system that can be accessed via a network portal;

FIG. 6 is an exemplary flowchart representation of several steps that may be involved during the creation of a release authorization;

FIG. 7 is an exemplary flowchart representation of several steps that may be involved during the use of a release authorization in a synchronous mode;

FIG. 8 is an exemplary flowchart representation of several steps that may be involved during the use of a release authorization in an asynchronous mode;

FIG. 9 is an exemplary authorization token;

FIG. 10 is an alternative exemplary authorization token;

FIG. 11 is a schematic diagram showing multiple entities and a sequential process that may be performed by the multiple entities to provide a chart forwarding feature that is consistent with at least some aspects of the present invention;

FIG. 12 is a flowchart illustrating a method that is consistent with the sequence shown in FIG. 11;

FIG. 13 is similar to FIG. 12, albeit showing a different method that is consistent with a portion of the sequence shown in FIG. 11;

FIG. 14 is a sub-process that may be substituted for a portion of the method shown in FIG. 12;

FIG. 15 is a flow chart illustrating another method that is consistent with at least some aspects of the present invention; and

FIG. 16 is a flow chart illustrating one additional method that is consistent with at least some aspects of the present invention.

### DETAILED DESCRIPTION

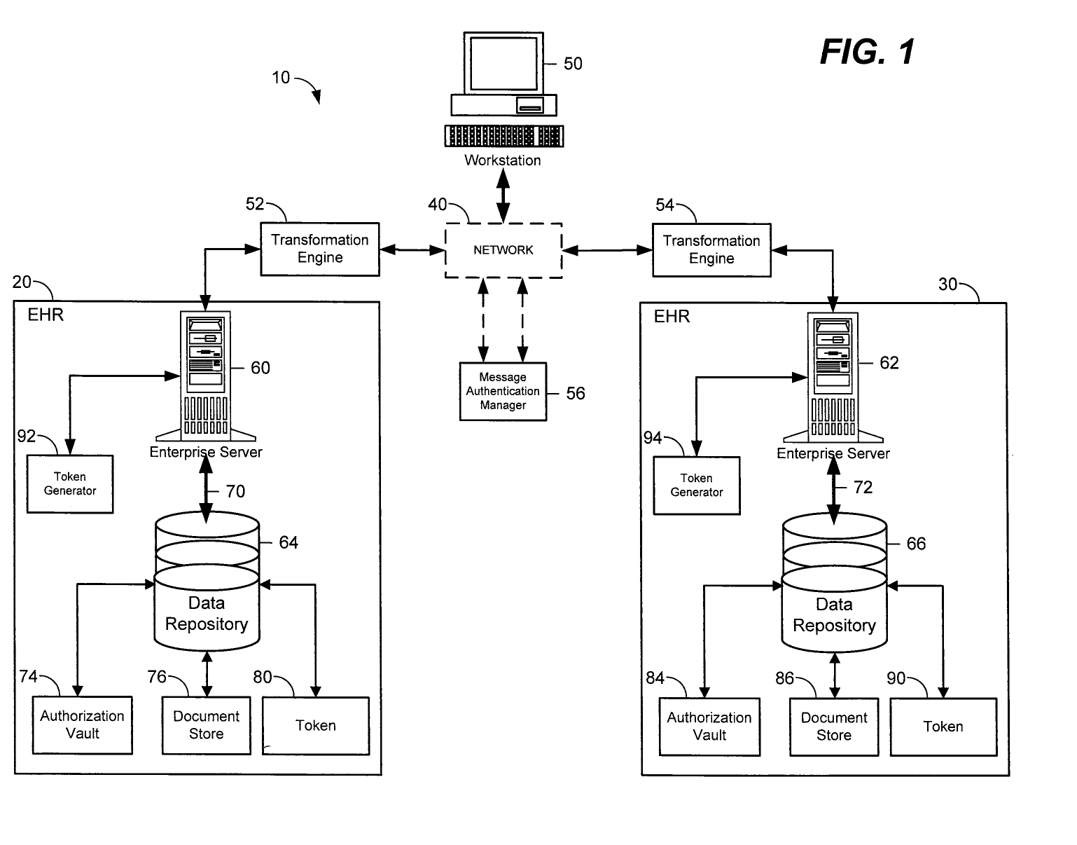

FIG. 1 illustrates an embodiment of an exemplary system 10 to provide a data sharing architecture that allows physically separate enterprises to share and exchange information. As an overview, the system 10 provides the ability for a Healthcare Organization (HCO) to create a release authorization that may be used by a second organization that adheres to a set of standards to request patient information from the HCO. As illustrated herein, the release authorization greatly improves the security of sensitive information that must be shared with other entities. By greatly enhancing the security of the system 10, users will have a much higher degree of trust in storing and sharing their sensitive and/or private information within the system.

The release authorization identifies, either directly or indirectly, the patient information authorized for transmission It may also optionally include an authorization token that identifies the release authorization and can be used by a second organization to facilitate the transfer of the information authorized for transmission. In addition, the token may serve as a vehicle of patient consent for a release of information because the patient, or the patient's guardian, would be empowered to give the authorization token to the second organization. I.e., a release authorization may be created that identifies information that may be transmitted when authorized, and the act of the patient giving the auth token to another organization serves as the authorization by the patient to share info with the second organization, i.e. any enterprise that requests the info may be assumed to be authorized because they would only know how to request the information if the patient had given them the release auth/auth token, thereby authorizing them. The term “token” should be construed in its broadest sense as tokens may take any number of forms that include, for example, paper, plastic, etc., or even an electronic form that can be transmitted to other organizations or is stored on any type of machine readable medium.

In cases where an authorization token is used, once the authorization token is received by a second organization the organization can scan or otherwise enter information from the token into its system. The token may include data associated with the destination system, how to connect to the destination system, and other identifying data that would allow the information authorized to be released to be identified at the first enterprise. Only the information that was authorized for release by the patient would be transmitted. Making the patient a part of the authorization and release process, and having the patient initiate the request, enables the patient to be in control of the process and minimizes confidentiality concerns.

The system 10 includes a first enterprise 20 in communication with a second enterprise 30 via a network 40. The term enterprise, organization, etc. as used herein mean any person or entity that might have a need to request patient information. The system 10 may also include a workstation 50 in communication with the enterprises 20, 30 via the network 40. The enterprises 20, 30 may be located, by way of example rather than limitation, in separate geographic locations from each other, in different areas of the same city, or in different states. Although the system 10 is shown to include two enterprises 20 and 30 and a single workstation 50, it should be understood that large numbers of enterprises may be utilized. For example, the system 10 may include a network 40 having a plurality of workstations and dozens of enterprises, all of which may be interconnected via the network 40.

The network 40 may be provided using a wide variety of techniques well known to those skilled in the art for the transfer of electronic data. For example, the network 40 may comprise dedicated access lines, plain ordinary telephone lines, satellite links, local area networks, wide area networks, frame relay, cable broadband connections, synchronous optical networks, combinations of these, etc., or any other data communication method. Additionally, the network 40 may include a plurality of network computers or server computers (not shown), each of which may be operatively interconnected in a known manner. Where the network 40 comprises the Internet, data communication may take place over the network 40 via an Internet communication protocol.

The system 10 may include transformation engines 52 and 54 coupled between the network 40 and the enterprises 20 and 30, respectively. The transformation engines 52, 54 will be discussed in more detail below. The system 10 may optionally include a message authentication manager 56 communicatively coupled between the enterprises 20 and 30. The message authentication manager 56 or a similar service may be incorporated to authenticate the validity of messages transferred between the enterprises 20, 30, as well as the workstation 50. An example of a message authentication manager is VeriSign Inc., which verifies that a message is sent from a particular location with the use of certain security keys, such as PKIs, etc.

The enterprises 20, 30 may include one or more enterprise servers 60, 62 that are coupled to one or more data repositories 64, 66 via links 70, 72. The enterprise servers 60, 62 may be servers of the type commonly employed in data storage and networking solutions. The servers 60 and 62 may be used to accumulate, analyze, and download data relating to a healthcare facility's medical records. Additionally, the servers 60 and 62 may be used to generate and facilitate the use of authorization tokens. Due to the flexibility in state-of-the-art hardware configurations, the server may not necessarily correspond to a single piece of hardware (i.e., a single server machine), although that may be the case. One of ordinary skill in the art will appreciate that a separate but connected server may serve the role of creating release authorizations for the data managed by the server(s) containing the patient data.

The enterprises 20, 30 may also include an authorization vault 74, 84 and a document store 76, 86 coupled to the data repository 64, 66. While the authorization vaults 74, 84 and the document stores 76, 86 are shown coupled to the data repositories 64, 66, those of ordinary skill in the art will appreciate that components 74, 76, 84, 86 could be implemented as part of the data repositories 64, 66. For example, information regarding release authorizations and corresponding information authorized for release may be stored in a dedicated data structure such as an authorization vault, or may be stored in data structures contained in a patient's electronic health record (EHR), or may be stored anywhere else. The invention simply requires the ability to store release authorizations and store related information such as information identifying the information authorized for release. The enterprise 20 may also optionally include an authorization token generator 92 coupled to the enterprise server 60. Similarly, the enterprises 30 may also include an authorization vault 84, a document store 86 and an authorization tokens 90 coupled to the data repository 66. The enterprise 30 may also optionally include an authorization token generator 94 coupled to the enterprise server 62. These components will be discussed in greater detail below.

The workstation 50 may include a display 96, a controller 97, a keyboard 98 as well as a variety of other input/output devices (not shown) such as a printer, mouse, touch screen, track pad, track ball, isopoint, voice recognition system, bar code scanner, Radio Frequency Identification (RFID) tag reader, RFID tag printer, biometric reader, magnetic data reader/writer, etc. Each workstation 50 may be signed onto and occupied by a user to assist them in performing their employment duties.

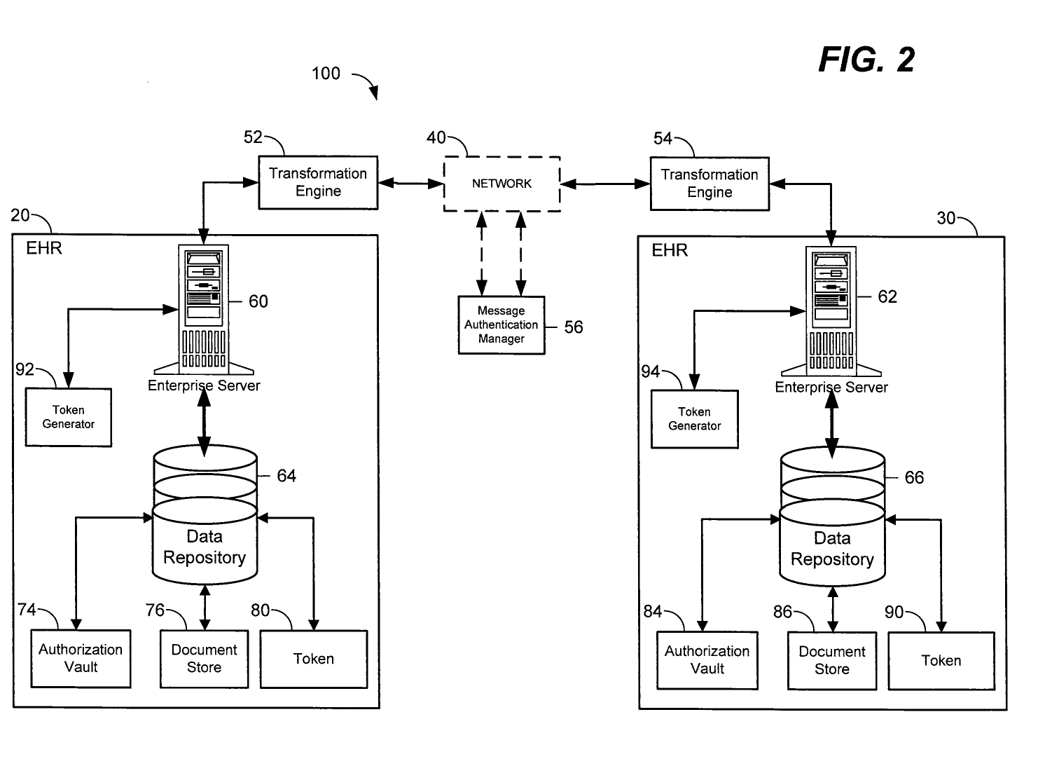

FIG. 2 illustrates an alternative embodiment of an exemplary system 100 to provide a data sharing architecture that allows enterprises to share and exchange information. The system 100 is similar to the system 10 shown in FIG. 1, except the system 100 does not include the workstation 50. FIG. 2 is an alternative embodiment of the patent wherein elements common to the system 10 are assigned like reference numerals. The system 100 includes a first enterprise 20 in communication with a second enterprise 30 via a network 40. The enterprises 20, 30 may be located, by way of example rather than limitation, in separate geographic locations from each other, in different areas of the same city, or in different states. Although the system 100 is shown to include two enterprises 20 and 30 and a single workstation 50, it should be understood that large numbers of enterprises may be utilized. For example, the system 100 may include a network 40 having a plurality of workstations and dozens of enterprises, all of which may be interconnected via the network 40.

The network 40 may be provided using a wide variety of techniques well known to those skilled in the art for the transfer of electronic data. For example, the network 40 may comprise dedicated access lines, plain ordinary telephone lines, satellite links, local area networks, wide area networks, frame relay, cable broadband connections, synchronous optical networks, combinations of these, etc., or any other data communication method. Additionally, the network 40 may include a plurality of network computers or server computers (not shown), each of which may be operatively interconnected in a known manner. Where the network 40 comprises the Internet, data communication may take place over the network 40 via an Internet communication protocol.

The system 100 may include transformation engines 52 and 54 coupled between the network 40 and the enterprises 20 and 30, respectively. The transformation engines 52, 54 will be discussed in more detail below. The system 100 may optionally include a message authentication manager 56 or a similar service coupled between the enterprises 20 and 30. The message authentication manager 56 will also be discussed in more detail below.

The enterprises 20, 30 may include one or more enterprise servers 60, 62 that are coupled to one or more data repositories 64, 66 via links 70, 72. The enterprise servers 60, 62 may be servers of the type commonly employed in data storage and networking solutions. The servers 60 and 62 may be used to accumulate, analyze, and download data relating to a healthcare facility's medical records. Additionally, the servers 60 and 62 may be used to generate and facilitate the use of release authorizations and associated information. Due to the flexibility in state-of-the-art hardware configurations, the server may not necessarily correspond to a single piece of hardware (i.e., a single server machine), although that may be the case. One of ordinary skill in the art will appreciate that a separate but connected server may serve the role of generating and facilitating the use of release authorizations and associated information for the data managed by the server(s) containing the patient data.

The enterprise 20 may also include an authorization vault 74 and a document store 76 coupled to the data repository 64. The enterprise 20 may also optionally include an authorization token generator 92 coupled to the enterprise server 60. Similarly, the enterprise 30 may also optionally include an authorization vault 84 and a document store 86 coupled to the data repository 66. The enterprise 30 may also optionally include an authorization token generator 94 coupled to the enterprise server 62. While the authorization vaults 74, 84 and the document stores 76, 86 are shown coupled to the data repositories 64, 66, those of ordinary skill in the art will appreciate that components 74, 76, 84, 86 could be implemented as part of the data repositories 64, 66. These components will be discussed in greater detail below.

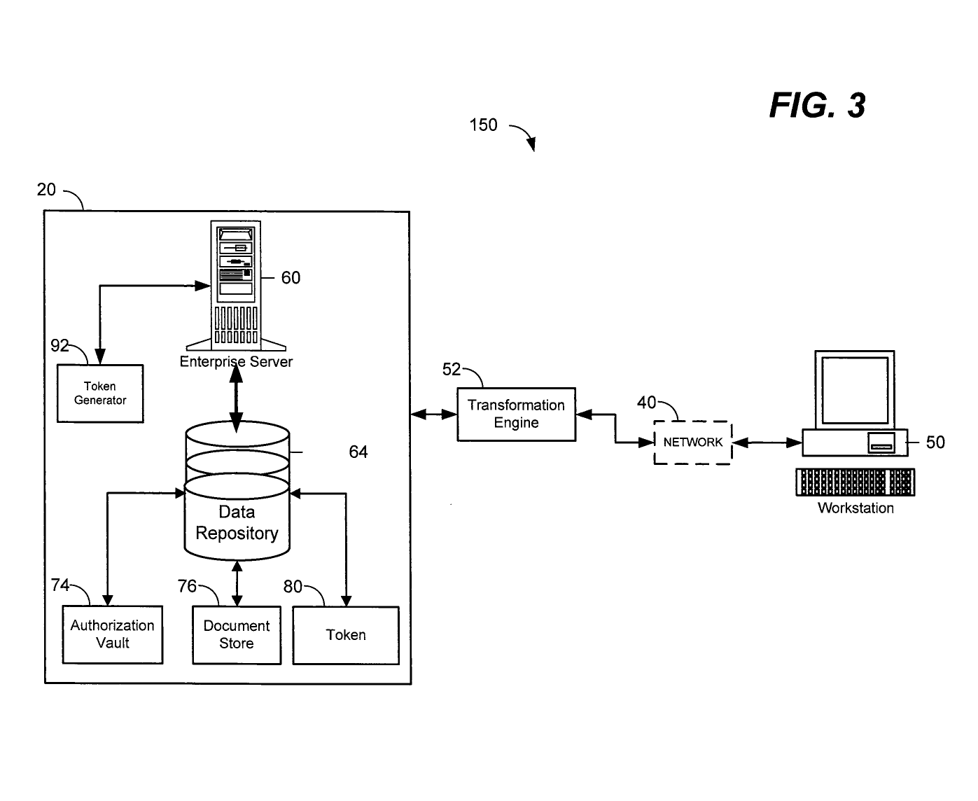

FIG. 3 illustrates an alternative embodiment of an exemplary system 150 to provide a data sharing architecture that allows physically separate enterprises to share and exchange information. The system 150 is similar to the system 10 shown in FIG. 1, except the system 150 does not include the second enterprise 30. FIG. 3 is an alternative embodiment of the patent wherein elements common to the system 10 are assigned like reference numerals. The system 150 includes a first enterprise 20 coupled to a transformation engine 52 which is in communication with a workstation 50 via the network 40. The enterprise 20 and workstation 50 may be located, by way of example rather than limitation, in separate geographic locations from each other, in different areas of the same city, or in different states. Although the system 150 is shown to include one enterprise 20 and a single workstation 50, it should be understood that large numbers of enterprises and/or workstations 50 may be utilized. For example, the system 150 may include a network 40 having a plurality of workstations and dozens of enterprises, all of which may be interconnected via the network 40.

The network 40 may be provided using a wide variety of techniques well known to those skilled in the art for the transfer of electronic data. For example, the network 40 may comprise dedicated access lines, plain ordinary telephone lines, satellite links, local area networks, wide area networks, frame relay, cable broadband connections, synchronous optical networks, combinations of these, etc., or any other data communication method. Additionally, the network 40 may include a plurality of network computers or server computers (not shown), each of which may be operatively interconnected in a known manner. Where the network 40 comprises the Internet, data communication may take place over the network 40 via an Internet communication protocol.

The system 150 may optionally include a message authentication manager or similar service (not shown) in communication with the enterprise 20 and the workstation 50. The message authentication manager will also be discussed in more detail below.

The enterprise 20 may include one or more enterprise servers 60 that are coupled to one or more data repositories 64 via link 70. The enterprise server 60 may be a server of the type commonly employed in data storage and networking solutions. The server 60 may be used to accumulate, analyze, and download data relating to a healthcare facility's medical records. Additionally, the server 60 may be used to generate and facilitate the use of release authorizations and associated information. Due to the flexibility in state-of-the-art hardware configurations, the server may not necessarily correspond to a single piece of hardware (i.e., a single server machine), although that may be the case. One of ordinary skill in the art will appreciate that a separate but connected server may serve the role of generating and facilitating the use of release authorizations and associated information for the data managed by the server(s) containing the patient data.

The enterprise 20 may also include an authorization vault 74, a document store 76 and an authorization tokens 80 coupled to the data repository 64. While the authorization vault 74, the document store 76 and the authorization tokens 80 are shown coupled to the data repository 64, those of ordinary skill in the art will appreciate that components 74, 76, 80 could be implemented as part of the data repository 64. For example, information regarding release authorizations and corresponding information authorized for release may be stored in a dedicated data structure such as an authorization vault, or may be stored in data structures contained in a patients electronic health record (EHR), or may be stored anywhere else. The invention simply requires the ability to store release authorizations and store related information such as information identifying the info authorized for release. The enterprise 20 may also optionally include an authorization token generator 92 coupled to the enterprise server 60. These components will be discussed in greater detail below.

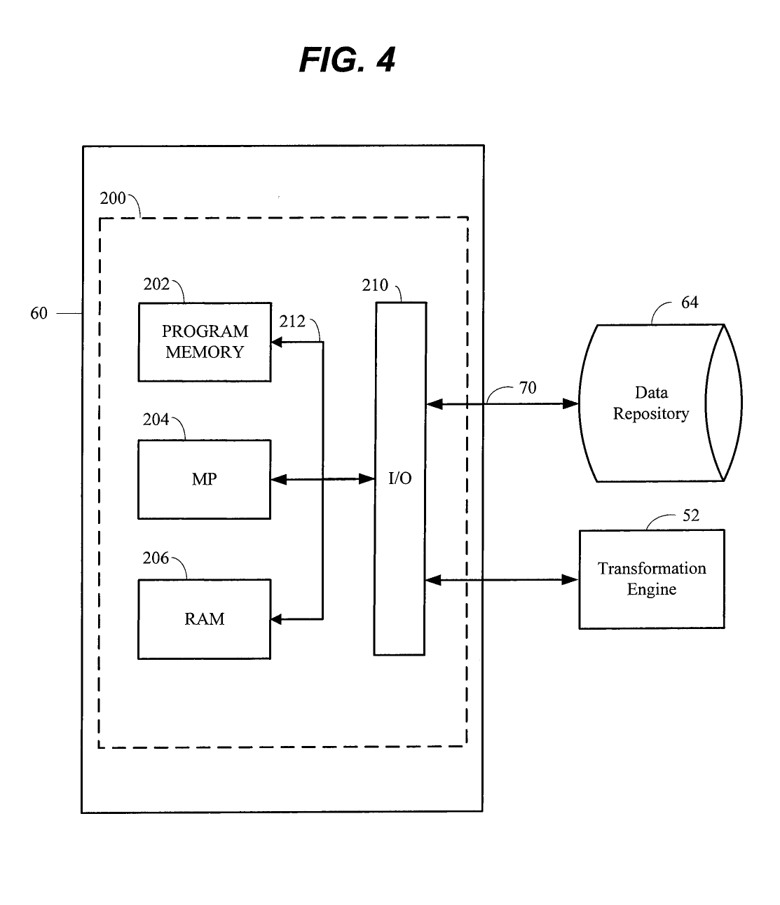

FIG. 4 is a schematic diagram of one possible embodiment of several components located in the enterprise 20 from FIG. 1. One or more of the enterprises 20, 30, as well as the workstation 50 from FIG. 1 may have the same components. Although the following description addresses the design of the enterprise 20, it should be understood that the design of one or more of the enterprises 20, 30 may be different than the design of other deployments 20, 30. Also, enterprises 20, 30 may have various different structures and methods of operation. It should also be understood that the embodiment shown in FIG. 4 illustrates some of the components and data connections present in an enterprise, however it does not illustrate all of the data connections present in a typical enterprise. For exemplary purposes, one design of an enterprise is described below, but it should be understood that numerous other designs may be utilized.

One possible embodiment of one of the enterprise servers 60 shown in FIG. 1 is included. The enterprise server 60 may have a controller 200 that includes a program memory 202, a microcontroller or a microprocessor (MP) 204, a random-access memory (RAM) 206, and an input/output (I/O) circuit 210, all of which may be interconnected via an address/data bus 212. It should be appreciated that although only one microprocessor 204 is shown, the controller 200 may include multiple microprocessors 204. Similarly, the memory of the controller 200 may include multiple RAMs 206 and multiple program memories 202. Although the I/O circuit 210 is shown as a single block, it should be appreciated that the I/O circuit 210 may include a number of different types of I/O circuits. The RAM(s) 206 and program memories 202 may be implemented as semiconductor memories, magnetically readable memories, and/or optically readable memories, for example. The controller 200 may also be operatively connected to the transformation engine 52.

All of these memories or data repositories may be referred to as machine-accessible mediums. For the purpose of this description, a machine-accessible medium includes any mechanism that provides (i.e., stores and/or transmits) information in a form accessible by a machine (e.g., a computer, network device, personal digital assistant, manufacturing tool, any device with a set of one or more processors). For example, a machine-accessible medium includes recordable/non-recordable media (e.g., read only memory (ROM); random access memory (RAM); magnetic disk storage media; optical storage media; flash memory devices), as well as electrical, optical, acoustical or other form of propagated signals (e.g., carrier waves, infrared signals, digital signals); etc.

The enterprise 20 may be coupled to the data repository 64 via the link 70. The link 70 may be part of a wide area network (WAN), a local area network (LAN), or any other type of network readily known to those persons skilled in the art.

Typically, the servers 60, 62 store a plurality of files, programs, and other data for use by the workstations 50 and other servers located in other enterprises. One server 60, 62 may handle requests for data from a large number of workstations 50. Accordingly, each server 60, 62 may typically comprise a high end computer with a large storage capacity, one or more fast microprocessors, and one or more high speed network connections. Conversely, relative to a typical server 60, 62, each workstation 50 may typically include less storage capacity, a single microprocessor, and a single network connection.

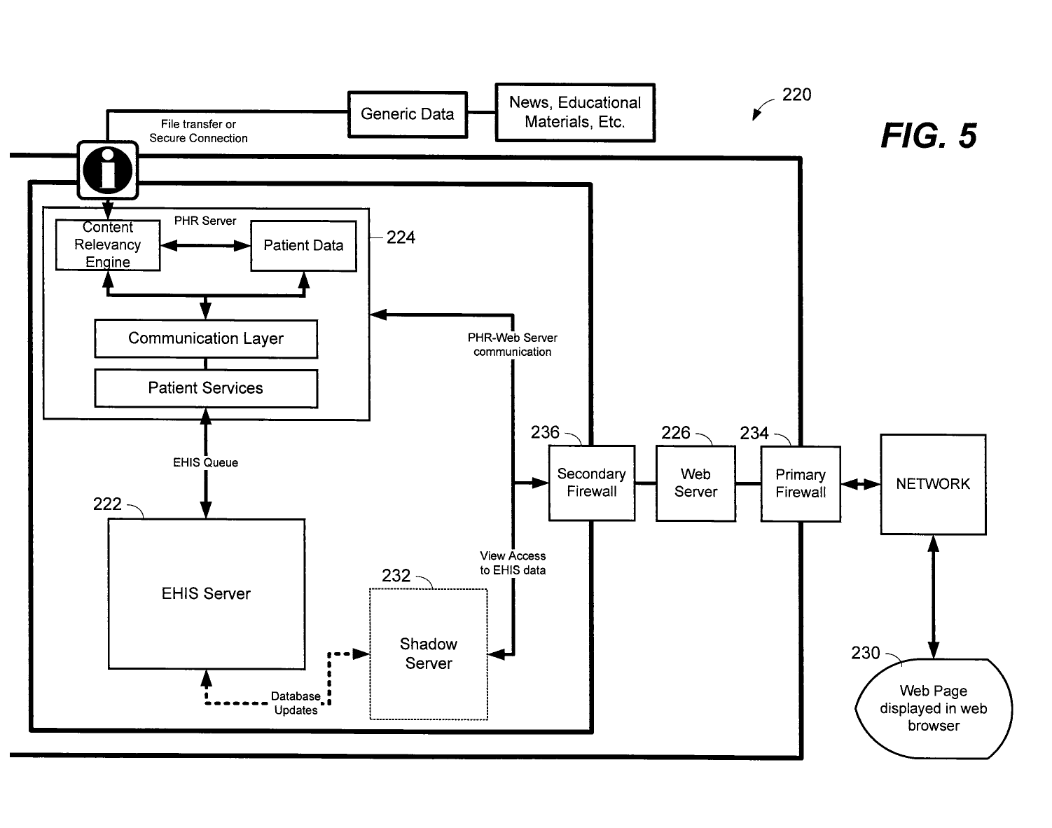

While it will be discussed in greater detail below, a patient or a person associated with a patient, such as, for example, a parent or guardian, may chose to generate a release authorization for a release of information by accessing an enterprise through a network portal, such as a patient web portal. The patient portal block diagram illustrated in FIG. 5 is an embodiment of an integrated patient/provider electronic medical record system, 220, that can be accessed via a network portal. The system 220 includes an Enterprise Healthcare Information System (EHIS) data server 222 to store provider-created patient health data and the routines for managing access and use of the data, a Personal Health Record (PHR) server 224 to store data entered by the patient and the routines for managing access and use of the data, and a web server 226 that stores routines for displaying the web page 230 and for managing online communication between a user logged into his web page and the PHR/EHIS servers 222, 224.

FIG. 5 also illustrates an optional shadow server 232 that maintains a copy of the EHIS server 222 and is used to make the EHIS server 222 highly available for EHIS system operations. In the embodiment of FIG. 5, the EHIS and PHR servers 222, 224 reside between a highly secure dual firewall configuration. In this configuration the web server 226 is protected by a primary firewall 234 and EHIS 222, shadow server 232 and PHR 224 servers are protected by a secondary firewall 236.

### Overall Operation of the System

One manner in which an exemplary system may operate is described below in connection with a block diagram overview and a number of flow charts which represent a number of routines of one or more computer programs.

As those of ordinary skill in the art will appreciate, the majority of the software utilized to implement the system 10 is stored in one or more of the memories in the controllers 60 and 60A, or any of the other machines in the system 10, and may be written at any high level language such as C, C++, C#, Java, or the like, or any low-level, assembly or machine language. By storing the computer program portions therein, various portions of the memories are physically and/or structurally configured in accordance with the computer program instructions. Parts of the software, however, may be stored and run locally on the workstations 50. As the precise location where the steps are executed can be varied without departing from the scope of the invention, the following figures do not address which machine is performing which functions.

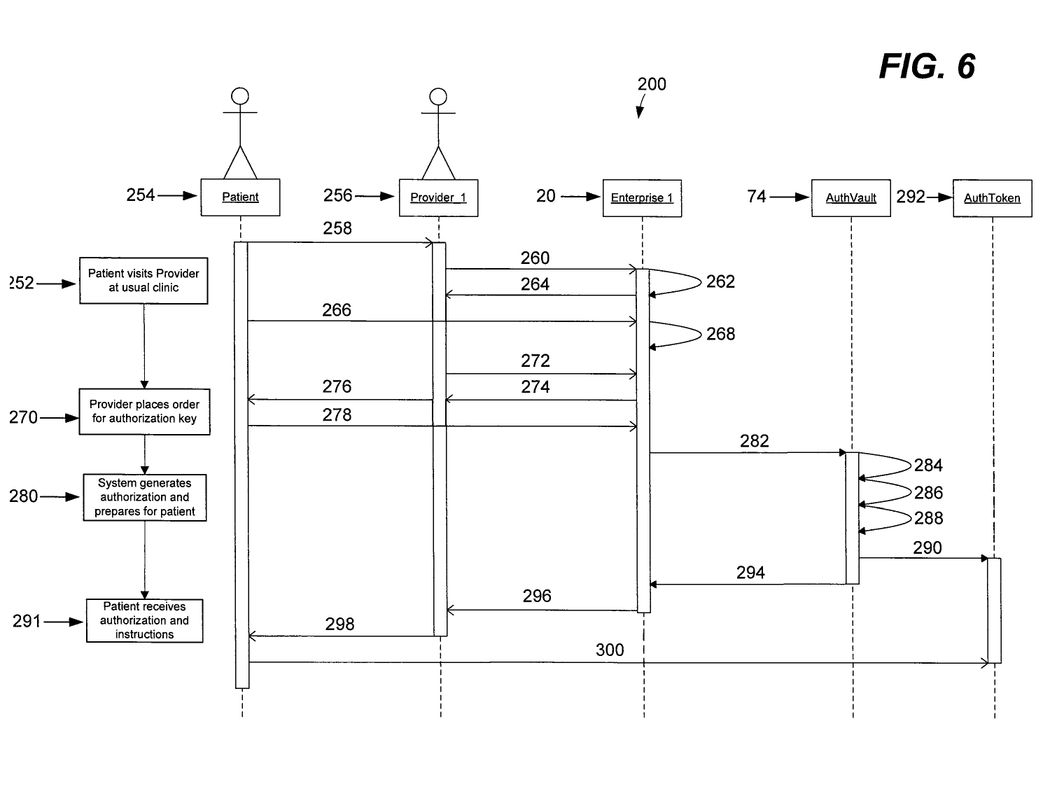

FIG. 6 is an exemplary flow diagram representation 200 of several steps that may be taken in creating a release authorization. At block 252, a patient 254 may visit a first provider 256 in his or her usual clinic and the first provider 256 may want to refer the patient to a specialty facility, where the specialty facility is part of a second enterprise. After the patient arrives at the first provider office 258, the patient may decide at that point that he or she would like to have a copy of their medical chart or other PHI made available to the second enterprise, the patient may agree to sign a patient consent form or otherwise authorize a release of information. The first provider, or another employee associated with the provider may submit an order 260 to the system 10 through a first enterprise 20, such as, for example, an Electronic Health Record (EHR) or any other healthcare software system that supports order entry so that a consent form is generated 262. The process of initiating the creation of a release authorization and/or consent form may be accomplished in numerous ways as one of ordinary skill in the art will appreciate, and is not limited to the use of an order or order entry system.

The consent form is then provided to the patient 264 so that the patient can execute the consent form, providing written or electronic authorization for the release of information. Once the patient signs the consent form 266, the form may be stored in paper format with the second enterprise, or stored electronically, or both 268. If the authorization is in electronic form, it may simply be stored in a data repository. It should be noted that an actual written signature may not be necessary, as alternative methods of generating release authorizations are available, such as, through a patient portal. When giving consent, the patient may decide what information he or she wants to release. The information could be very limited, very liberal, or a blanket authorization to share all PHI related to that patient. Thus, the system 10 may be adapted to provide a very granular level of information release that is selectable by the patient. The system 10 could also support electronic signature (e-sig) for this; for example, a patient may sign an electronic tablet to put their signature into the system; as new technologies develop, such as the use of digital and electronic signatures, personal identification certificates, biometrics, and the like, those could be used as well (i.e. patient plugs in a flash drive or touches a fingerprint reader and their identity is confirmed).

When using an order to initiate the creation of a release authorization, as shown at block 270, the provider may submit the order 272 to the system 10 through the first enterprise 20. The system 10 may then submit questions to the provider 274 and the provider, in turn, may submit these questions to the patient 276. In answering the questions 278, the patient determines what data he or she wants to share with the second enterprise. One way of selecting what information to make available is to use order specific questions to get answers about what data to share with the second enterprise. For example, there may be a question on whether to include behavioral health visits, which could include a default value of ‘no.’ There may be other questions, such as whether or not information pertaining to sensitive encounters, medications the current visit, date range, etc. should be authorized for release. As one of ordinary skill in the art will appreciate, questions may be created to facilitate decisions regarding the sharing of any PHI. In addition to using questions to identify the information to be shared, questions can be used to aid in determining any other parameters relating to the release authorization. Other possibilities might be to include who the data may be shared with, or whether the use will be a one time authorization or a multiple time authorization, whether or not it includes an expiration date, whether or not it may include any information to be collected in the future, or whether or not it is restricted to specific organizations that the patient identifies or may be used by any authenticated organization, etc. The process of determining what information to share may be accomplished in numerous other ways as one of ordinary skill in the art will appreciate, and is not limited to the use of questions. It may not even need to be a provider facilitating this process, as it may be the personnel that currently administer the release of information or any other user trained in the use of the system. Further, the patient can have more than one authorization token and each one might release different levels of information or have different restrictions.

The patient could also limit the identification data associated with the information authorized to be released so that an anonymous encounter may occur at the second enterprise. In other words, the patient may request that no data identifying the patient be released from the first enterprise. That is, a patient could create a release authorization excluding personally identifying information, and go to another medical center anonymously e.g., an anonymous sexually transmitted disease (STD) clinic or the like. While they would be anonymous, e.g. no one would know their name or identity, they could still provide relevant PHI to the organization receiving the information authorized to be released. Another example would be a patient with a sensitive condition seeking care under an alias, or a famous person seeking care under an alias.

At block 280, the system 10 may then generate the release authorization for the patient according to the parameters, conditions, and limits the patient has provided. The system 10 may optionally create an appropriate data structure to store the request for the release of information 282. The system 10 may optionally also create an authorization token, in addition to generating a number of keys 284, such as, for example, a key for a request number and a key for a health enterprise identifier. Alternatively, any number of additional keys might also be generated, such as, for example, a key for a patient sequence number, a key for an additional PIN, etc. These additional keys could also be generated as part of the key for the request number. In other words, the key generated for the request could incorporate information associated with the patient as well as information associated with a particular authorized release of information. The system 10 may then compress all of the indices (keys) into a single authorization key 286. The authorization key may also be encrypted for additional security. Those of ordinary skill in the art will also appreciate that the individual keys could also be encrypted before they are compressed. For example, the information associated with the health enterprise identifier may include an IP address and a port number or URL that the first enterprise wants to encrypt for security reasons.

The information associated with the keys may then be stored 288 in the authorization vault 74. As discussed below, the authorization vault may be used later in the process to validate a release authorization for an incoming request for information. The system 10 may generate 290 the optional authorization token 292 in any one of a number of available formats. For example, the key could be printed onto a piece of paper in a bar coded format or as any other text, coded, or graphical rendering; an RFID tag could be created; a magnetic medium or semiconductor device could be encoded; an optical medium could be encoded; any other computer-accessible medium could be encoded; or any other method readily known to those of ordinary skill in the art. After the system 10 finishes creating the optional authorization token 294, the first enterprise 20 may then allow the optional authorization token to be printed or encoded and the provider may then give it to the patient 296.

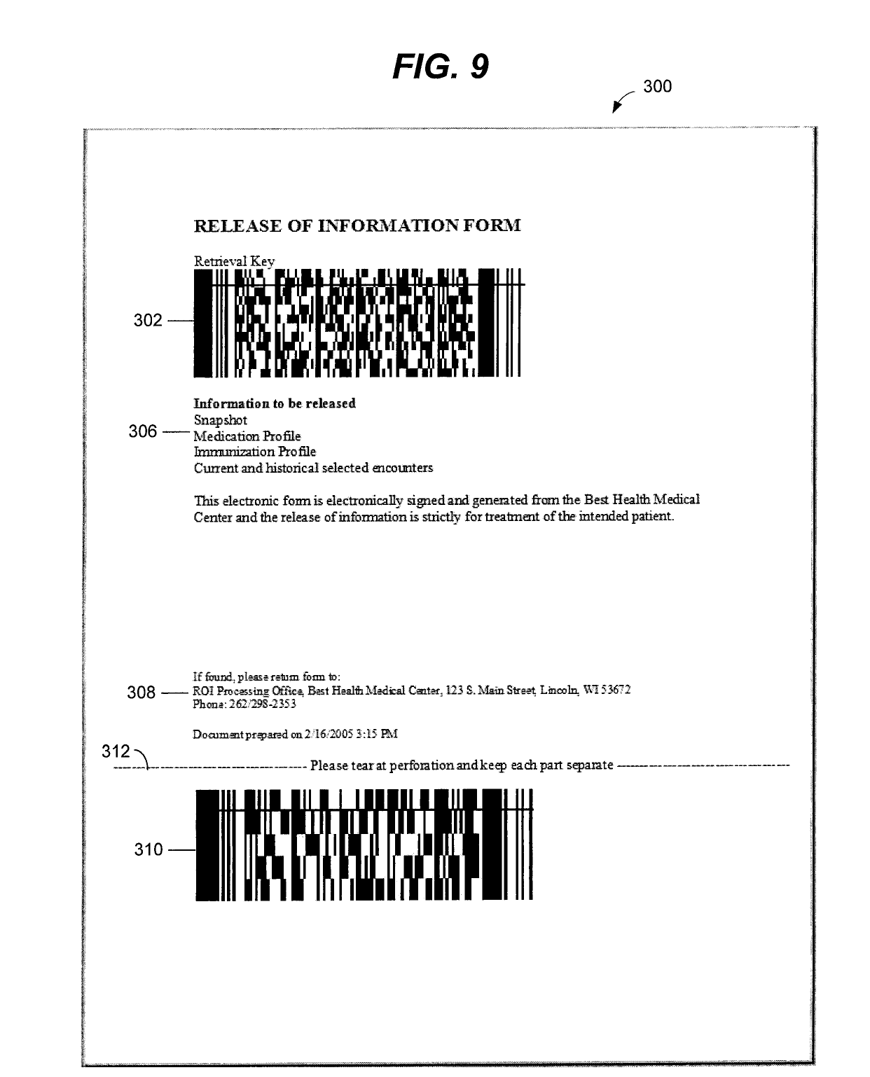

An optional PIN may also be generated or chosen and entered by the patient and associated with the release authorization. A common PIN could be used if more than one release authorization is generated, but while a common PIN could be used, a separate PIN for each could be used, or any combination. The PIN could be encoded and printed on the bottom of the optional authorization token, which could include a perforation so that the PIN can be kept separate simply by tearing the token into two. An example of an optional authorization token 300 that is printed on paper and includes a separate PIN is illustrated in FIG. 9. This use of the separate PIN would add an extra layer of security to the information being shared, which may be especially useful for highly confidential or classified information.

It is contemplated that the optional PIN(s) could be alpha, numeric, or alphanumeric passwords that are memorized and easily remembered by the patient. The PIN(s) could also be biometric data that is read with the use of a voice recognition system, an iris reader, a fingerprint scanner, or any other biometric reader known to those of ordinary skill in the art. It should be noted that, besides a PIN, extra information can be associated with the release authorization for other uses, such as, for example, to trigger email alerts, etc.

The exemplary authorization token 300 includes a retrieval key 302 and a summary 306 of the information that will be released by the use of the authorization token. For example, the summary 306 may include a patient snapshot, a medication profile, an immunization profile, current and historical selected encounters. The authorization token 300 also includes information 308 associated with the first enterprise 20, such as a telephone number, a mailing address, an email address, a network address, information regarding how information to be released may be requested, etc. While information that identifies the patient associated with the release authorization 300 could be printed on the token, it is most likely the case that no revealing information would be printed on the authorization token 300. The authorization token 300 may also include an additional key 310 encoding a PIN located below a perforation 312. As discussed previously, the method of using an authorization token is optional, as the information needed to initiate a request to transfer information may be provided verbally by the patient, by pre-coordination between entities with established relationships, via an electronic request authorization, etc.

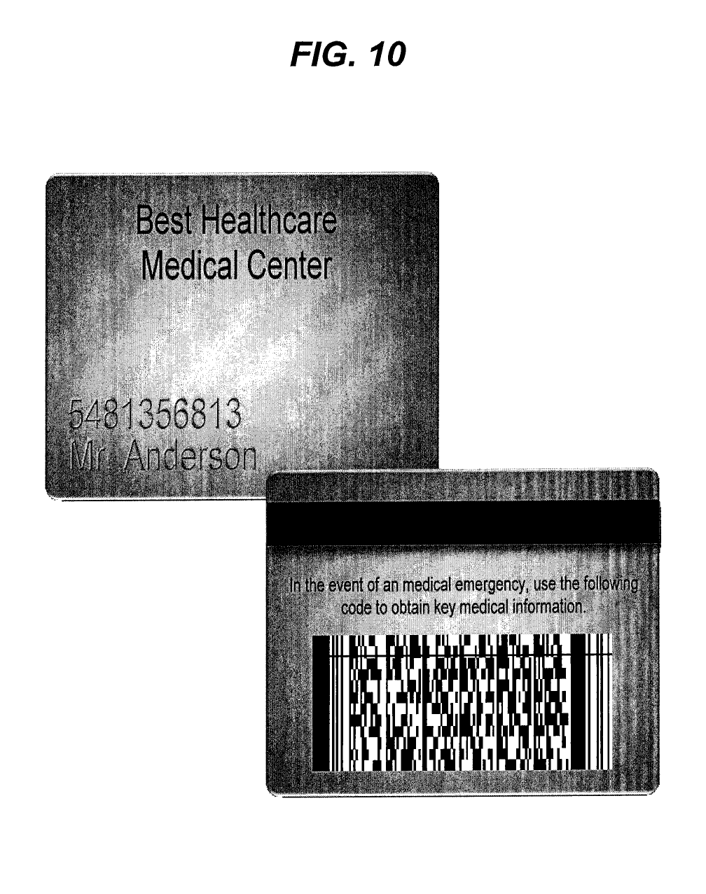

A plethora of alternative embodiments for the optional authorization token are envisioned. Some examples include smart cards; ticket vouchers; cards with a magnetic strip applied to a surface; cards that are printed with optically readable material such as ink; cards with magnetic, optical, or semiconductor storage; cards with embedded RFID tags; any other computer-accessible medium; etc. An example of a printed card is illustrated in FIG. 10.

Referring again to FIG. 6, after the optional authorization token is generated 296, the patient may be given instructions 298 on use of the authorization token before leaving the first enterprise with the token 300. The patient would not have to actually leave with the token in some scenarios, such as when the token is electronically transmitted to the organization(s) authorized to receive PHI, when the token is generated and made accessible to the patient through his or her personal health record or a network portal, or when no token is used.

If the patient has access to the first enterprise through a system similar to the system 220 from FIG. 5, the patient may be able to generate their own release authorization from a workstation 50, view a summary of existing authorization tokens, and review information related to the use of the authorization tokens. Further, the patient may be able to modify or revoke existing release authorizations. Such a situation would be functionally similar to the above-described process; a patient would access an activity indicating they would like to create a release authorization. They would then indicate the information authorized to be shared, specify other parameters of the release authorization, and identify limitations of the release authorization such as limiting the release authorization to a single use, limiting the release authorization to a predefined number of uses, limiting the use of the release authorization to a date range, limiting the use of the release authorization to a particular episode, limiting the use of the release authorization according to one or more policies of the EHR enterprise, limiting the use of the release authorization to one or more specific recipient entities. etc., and then create the release authorization, without the need for their provider or any other staff to be present or involved. They may then optionally create an authorization token if desired.

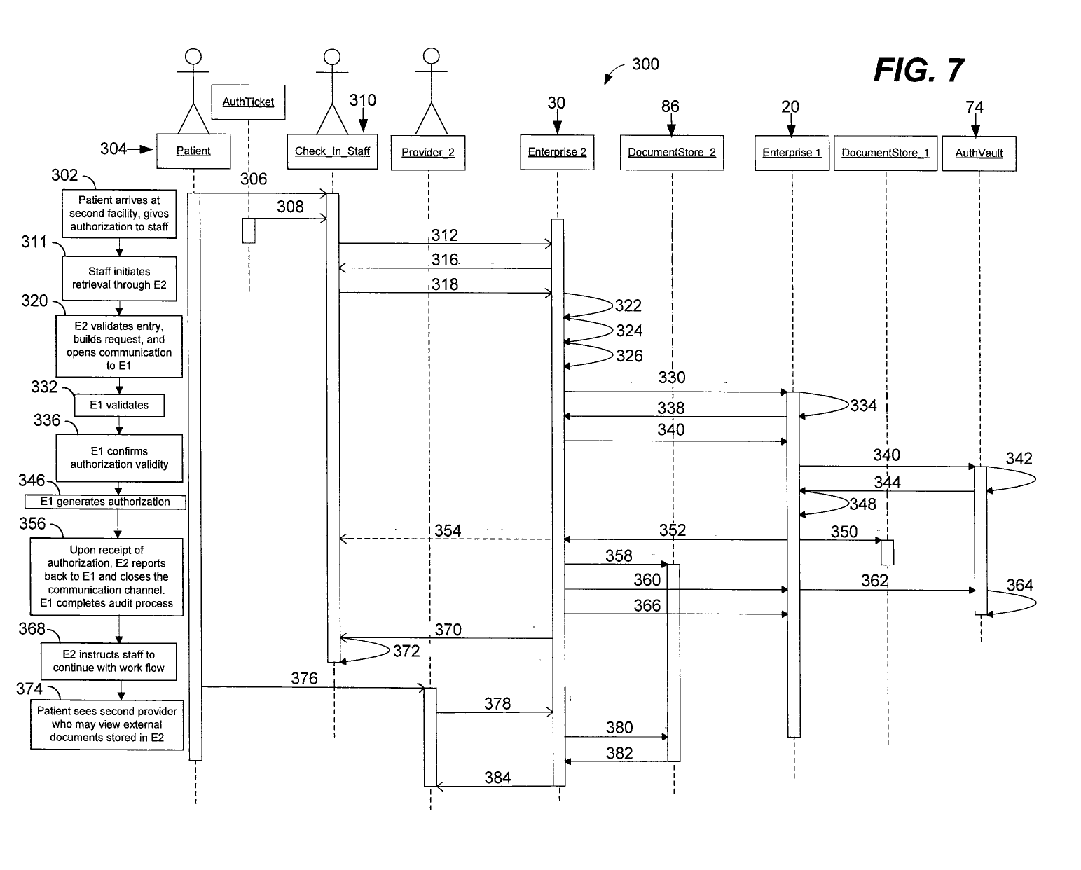

FIG. 7 is an exemplary flow diagram representation 300 of several steps that may be taken in using a release authorization in a synchronous mode. At block 302, the flow diagram 300 may begin when a patient 304 visits the second provider at the second enterprise 30. Upon arrival, 306 the patient may present 308 the authorization token, and PIN if one is used, to the second staff 310. At block 311, the second staff may then initiate the retrieval of the external information 312 through the second enterprise 30 by accessing a ‘retrieval of authorized released information’ function. The second enterprise 30 may then return 316 an entry form to the staff 310. The staff 310 may the complete 318 the form. Completing the form may include entering the key and the PIN. The method of entering the key and PIN are dependent on the format in which the keys and PIN are stored. If an EHR system, such as EHR 30 is not used, staff can use the information source's portal, or if a PHR system is used, the PHR system can supply the portal/function. As one of ordinary skill in the art will appreciate, while the second enterprise 30 may be a healthcare organization, it does not have to be. Other entities that have a use for PHI, such as insurance companies, payer organizations, life insurance and other benefit companies, employers, law firms, etc. may receive information authorized to be released in the same fashion as described above when referring to the enterprise 30.

At block 320, the second enterprise 30 then validates that the keys entered are of a valid format 322, builds a request string with a return address 324 for the second enterprise 30, and attaches any additional information, such as information about the second enterprise 30. This information may be used for auditing purposes or for generating alerts at the first enterprise 20. It could also be used as part of a determination regarding a version of the data that has previously been sent from the first enterprise 20 to the second enterprise 30.

The second enterprise 30 then generates a request 326 by identifying and then establishing 330 a communication channel with the EHR 1 system, 328. The first enterprise 20 may then process the request for information and, at block 332, authenticate the validity of the request for information from the second enterprise 30 by processing a validation request 334. This could include determining that the request includes the correct patient, the correct PIN, the correct key, etc. Processing the request for information 334 could also include retrieving information associated with the release authorization, such as, for example, information related to which patient is associated with the release authorization and what information the release authorization authorizes to be released. This could also include validating the requester by determining if the second enterprise 30 is a valid and appropriate user and/or organization. The message authentication manager 56 may assist in this determination by authenticating that the message is coming from where the message says it is coming from. Further, the second enterprise 30 may choose to use a third-party to facilitate the sharing of information, for example, a clearinghouse or any entity empowered to store PHI on behalf of the second enterprise 30.

Information to be transmitted can be generated in a variety of formats to accommodate differing levels of interoperability standards. For example, information could be transmitted as unstructured text, structured text, coded data, or any mixture thereof. The information may also be transmitted in a format conforming to any defined protocol.

At block 336, the first enterprise 20 may then send the authorization approval status back 338 to the requester 314 and may then confirm that the authorization token is still valid, and not previously used, revoked, expired, etc. The requestor 314 may then send a request 340 back to the first enterprise 20 generate the authorization. The first EHR 328 may then validate the authorization 342, store an audit copy of the authorization in the authorization vault 74, and generate a validation result 344. At block 346, the first enterprise 20 may generate the authorization 348. Information associated with the release authorization and the validation may be stored 350 in the authorization vault 74 for audit purposes and to mark the release authorization as having been used. If the first enterprise 20 validates the request, requested information is retrieved and sent 352 to the second enterprise 30. The second enterprise 30 then presents activity information 354 to an employee at the second enterprise 30 regarding the status of the requested information. At block 356, the second enterprise 30 receives the information synchronously, stores 358 with proper indices the sent information in the document store 86, and sends a receipt status 360 to the first enterprise 20.

A confirmation receipt may be generated 362 and stored 364 in the authorization vault 74 at the first enterprise 20. The first enterprise 20 may close 366 the communication channel with the second enterprise or resend any information that failed to be transmitted, as well as updating information on the release authorization (expiring if one time use, etc.). At block 368, the second enterprise 30 then notifies 370 the staff 310 to continue with the check-in workflow. The staff 310 then may complete 372 the patient 304 check-in. The information is then available at the second enterprise 30. At block 374, the patient may see the second provider 376. During consultation, the second provider 376 may request 378 the received external information from the requester 314. The requester 314 may then retrieve 380 the external information from the document store 86, and the document store 86 may return 382 the information to the requester 314. The requestor 314 may then display 384 the external information to the second provider 376. After the second provider consults with the patient, the patient can request a release of information back to the first provider at the first enterprise 20. The process of creating this return authorization may be streamlined by including it at any point in the above process or doing it as a separate step.

The information retrieved for transmission may be sent in several different formats, such as PDF, XML, Word, CDA (an implementation template that validates the information in it before it is transported), CCR (a document template with sections), etc. If the information is sent in only one format, the transformation engine 52 could be used to convert it into other formats. Information transmitted may be accompanied by a basic set of information, such as the author, organization, version, date/time created, etc. as appropriate. An index page may also be generated along with the information that the patient has agreed to share. When the information is stored in the documents store 86 at the second enterprise, it may be stored as external information to the patient's chart.

The flow diagram 300 thus illustrates how the sensitive information stored at the first enterprise 20 may be shared with another enterprise without ever giving the other entity the ability to create, modify, or delete the existing information stored at the first enterprise, which ensures the integrity of the data while simultaneously protecting the data from unwarranted access.

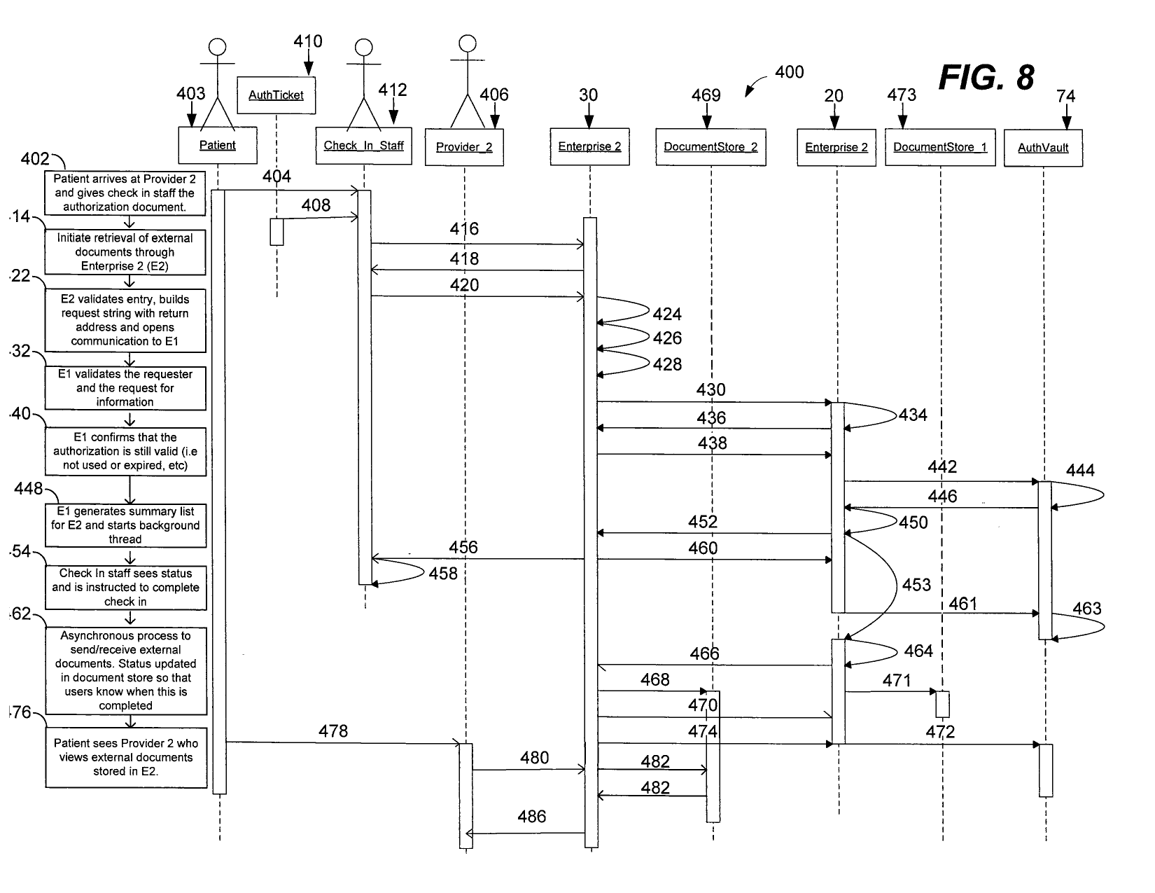

FIG. 8 is an exemplary flow diagram representation 400 of several steps that may be taken in using a release authorization in an asynchronous mode. The flow diagram 400 may begin at block 402 when a patient 403 visits 404 the second provider 406 at the second enterprise 30. The patient may present 408 (if applicable) the authorization token 410, and PIN if one is used, to the second provider check-in staff 412. At block 414, the check-in staff 412 may then initiate the retrieval of the external information through the second enterprise 30 by accessing a ‘retrieval of authorized released information’ function 416. This may include entering the key and the PIN. The method of entering the key and PIN are dependent on the format in which the keys and PIN are stored. If an EHR system, such as EHR 30 is not used, staff can use a network portal that accesses EHR 120. The second enterprise presents 418 an entry form for the information to the check-in staff 412, and the staff 412 completes the form and sends 420 it back to the second enterprise 30.

At block 422, the second enterprise 30 then validates that the keys entered are of a valid format 424, builds 426 a request string with a return address for the second enterprise 30, and attaches any additional information, such as information about the second enterprise 30. This information may be used for auditing purposes or for generating alerts at the first enterprise 20. It could also be used as part of a determination regarding a version of the data that has previously been sent from the first enterprise 20 to the second enterprise 30.

The second enterprise 30 then generates a request 428 by identifying and then establishing 430 a communication channel with the first enterprise 20. The first enterprise 20 may then process the request for information and, at block 432, authenticate the validity of the request for information from the second enterprise 30. This could include determining that the request includes the correct patient, the correct PIN, the correct key, etc. This could also include validating the requester by determining 434 if the second enterprise 30 is a valid and appropriate user and/or organization. The message authentication manager 56 may assist in this determination by authenticating that the message is coming from where the message says it is coming from. The organization requesting the information can be a third party organization, such as a clearinghouse or any entity empowered to store PHI on behalf of the receiving organization. The first enterprise 20 may then send 436 an approval status to the second enterprise 30. The second enterprise 30 may then send 438 the request to the first enterprise 20.

Information to be transmitted can be generated in a variety of formats to accommodate differing levels of interoperability standards. For example, information could be transmitted as unstructured text, structured text, coded data, or any mixture thereof. The information may also be transmitted in a format conforming to any defined protocol.

At block 440, the first enterprise 20 may then confirm 442 that the release authorization is still valid, and not previously used, expired, revoked, etc. Information associated with the release authorization and the validation may be stored in the authorization vault 74 for audit purposes and to mark the release authorization as having been used 444. If the enterprise 20 validates 446 the request, at block 448, the first enterprise 20 generates 450 a summary list of what information will be transmitted to the second enterprise, and the summary list is transmitted 452. The first enterprise 20 then triggers an asynchronous process 453 to generate and send the information authorized for release to the second enterprise 30.

The second enterprise 30 receives the summary list, saves the expected deliverables, and prepares to receive the information. At block 454, the status is displayed to the check-in staff 412 at the second enterprise wherein the staff is instructed 456 to continue with the check-in of the patient. The check-in staff 412 may then complete 458 the check-in process and send 460 a receipt status back to the first enterprise 20. The first enterprise 20 may then send 461 a confirmation of delivery to the authorization vault 74, and the authorization vault 74 may audit 463 the authorization and store the audit in the vault 74.

At block 462, the requested information is generated 464 and sent 466 to the second enterprise 30. The first enterprise 20 asynchronously sends 466 the information to the second enterprise 30, and the second enterprise 30 may store 468 the information in the second document store 469 as it is received. The first enterprise 20 may store 471 the information in the first document store 473. The second enterprise 30 updates the summary list and updates the status in the document store 86 so that the appropriate entity, e.g., check-in staff, or other system user e.g., care provider, or other designated entity within the organization is notified when the all information has been received. The second enterprise then sends 470 the first enterprise 20 confirmation receipt(s) for the information received.

The confirmation receipt(s) may be stored 472 in the authorization vault 74 at the first enterprise 20. The first enterprise 20 may close 474 the communication channel with the second enterprise or resend any information that failed to be transmitted, as well as updating information on the release authorization (expiring if one time use, etc.). At block 476, the information is then available for viewing by the second provider when the patient sees 478 the provider 406. The second provider 406 may then request 480 the information from the second enterprise 30 and the enterprise may retrieve 482 the information from the document store 469. The store 469 may return 484 the information to the enterprise 30 and the enterprise will show 486 it to the provider 406. After the second provider consults with the patient, the patient may request a release of information back to the first provider at the first enterprise 20.

The information retrieved for transmission may be sent in several different formats, such as PDF, XML, Word, CDA (an implementation template that validates the information in it before it is transported), CCR (a document template with sections), etc. If the information is sent in only one format, the transformation engine 52 could be used to convert it into other formats. Information transmitted may be accompanied by a basic set of information, such as the author, organization, version, date/time created, etc. as appropriate. An index page may also be generated along with the information that the patient has agreed to share. When the information is stored in the documents store 86 at the second enterprise, it may be stored as external information to the patient's chart.

The optional authorization token shown in the form of an authorization card in FIG. 10 could be adapted for use both with and without a PIN. This could be useful for a person that is carrying the authorization card on them, but is unconscious when being treated or when at an emergency department. The release authorization may be configured so that none or only a portion of the information authorized for transmission is transmitted when only the release authorization is used, and so that all of information authorized for transmission is transmitted when the release authorization and the PIN are both used by. Furthermore, the portion of the information to be transmitted in the absence of a PIN, if any, may be established by the patient, an agent or proxy for the patient, an agent of the organization, policies of the organization, etc. The authorization card could thus be used to obtain a minimal amount of information about the patient, such as current medications and medication allergies, which may be critical life saving information in an emergency setting.

This process would include the input of the authorization key from the authorization card by a staff member associated with the enterprise treating the patient, establishing a communication channel with the patient's home enterprise and the communication of a request for information back to the patient's home enterprise. The treating enterprise may also combine the keys, regenerate communications sequences, attach its own address information, as well as any additional information.

The home enterprise may then process the request for information and authenticate the validity of the request from the treating enterprise. The home enterprise may check for expiration of the release authorization and authenticity of the treating enterprise. The home enterprise may then generate basic summary of information that has been authorized for release from the home enterprise. The home enterprise may then receive a confirmation from the treating enterprise.

The treating enterprise receives the information and stores the information transmitted as external information in a memory with proper indices. The treating enterprise may report back to the home enterprise whether the information was received properly. The home enterprise may close the communication channel with the treating enterprise or resend any information that failed transmission to the treating enterprise. The home enterprise may update audit information on the release authorization, and the treating enterprise may instruct the check-in staff to continue with the workflow.

Chart Forwarding Function

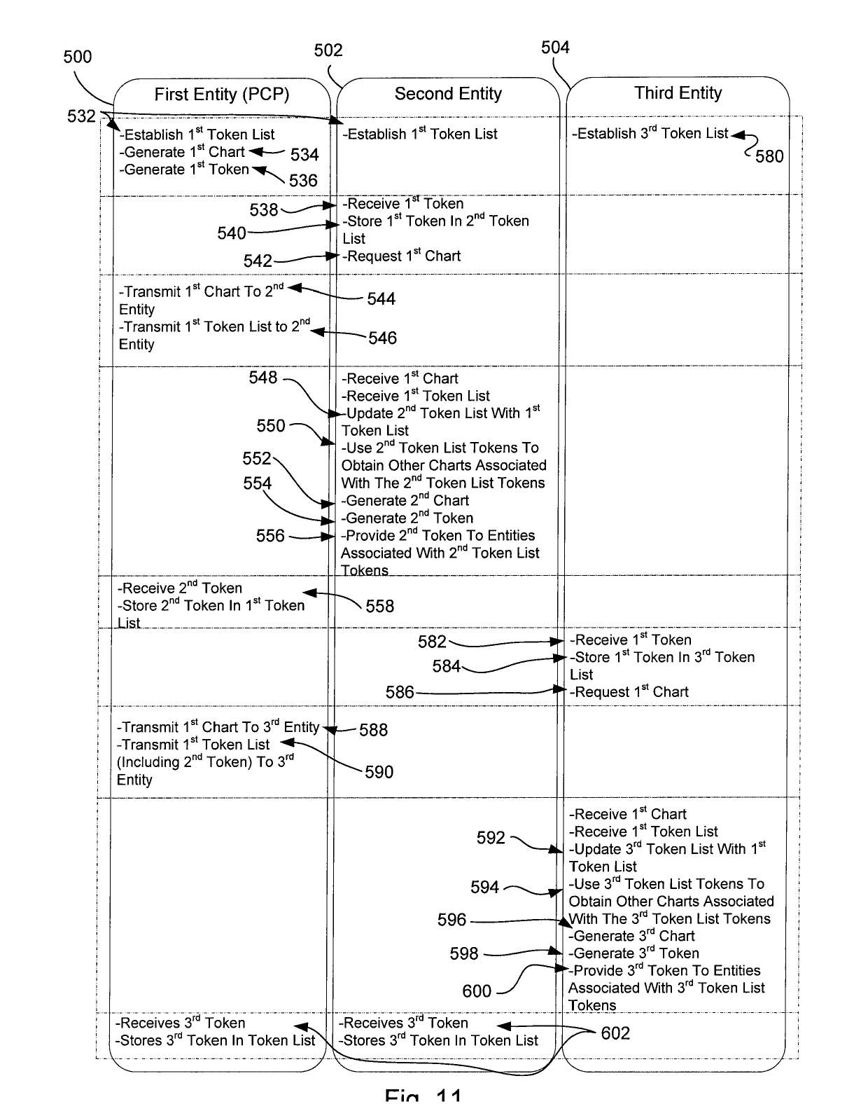

In addition to the features described above, in at least some embodiments it is contemplated that a chart forwarding feature or function may be implemented in at least some inventive embodiments. Here, the chart forwarding feature ensures that any charts associated with a patient, regardless of the entity that generates and stores the charts, are made available to other entities that need access to and are authorized to access the charts. In addition, this feature ensures that all entities receive charts from source entities thereby ensuring that all charts are up to date. For instance, referring to FIG. 11, first, second and third entities are shown 500, 502 and 504, respectively, where each entity includes a processor to perform software programs. Assume that the primary care physician for a first patient is affiliated with a first facility referred to as first entity 500 in FIG. 11 and therefore that entity 500 stores a first chart associated with the first patient. Also assume that when the first patient visits a second entity 502 (e.g., a second facility), the second entity accesses the first chart for the first patient and generates and stores a second or local chart for the first patient. Now, when the first patient visits a third entity 504, when the third entity uses a token to access the first chart, in many cases it will be important that the third entity have access to both the first and second charts in order to make informed decisions regarding the patient. The chart forwarding feature ensures that, as different entities generate their own separate charts for a patient, a single token can be used by any entity to gain access to all charts regardless of which entities generated and currently store the charts.

To provide the chart forwarding feature, a system is contemplated wherein, when a chart is requested and received using a token, the receiving entity stores the token used to request the chart so that the token can be provided subsequently to other entities. In addition, when a second entity uses a first token to access a chart stored by a first entity and then generates and stores a subsequent second chart, the second entity may be programmed to generate a second token either automatically or when a second token is requested that can be provided to the first entity for storage. Here, despite each of the entities storing different charts for the same patient, each entity also stores a token associated with the chart stored by the other entity which can be used to access the chart stored by the other entity. Where more charts and entities exist and the additional entities access charts maintained by either of the first or second entities, each entity ends up maintaining its own chart and a token list including separate tokens associated with each of the other charts that is maintained for a patient by any of the other entities.

In the above example, when any one of the first or second tokens is provided to a third entity to enable access to an associated one of the first and second charts, the entity receiving the request and the token from the third entity, in addition to providing access to the chart associated with the received token, provides the other token(s) in the token list to the third entity thereby enabling the third entity to access the other charts. Thus, for instance, where a third entity uses the first token to access the first chart, the first entity also provides a first token list maintained by the first entity to the third entity enabling the third entity to access the second chart (i.e., in the above example the first token list maintained by the first entity includes the second token). Similarly, if the third entity uses the second token to access the second chart, the second entity also provides the second token list including the first token to the third entity enabling the third entity to access the first chart at the first entity. In this way, if any entity is aware of the existence of charts which the other entities are unaware of, existence of the charts is communicated to the requesting entity along with the necessary information (e.g., a token) needed for obtaining the chart.

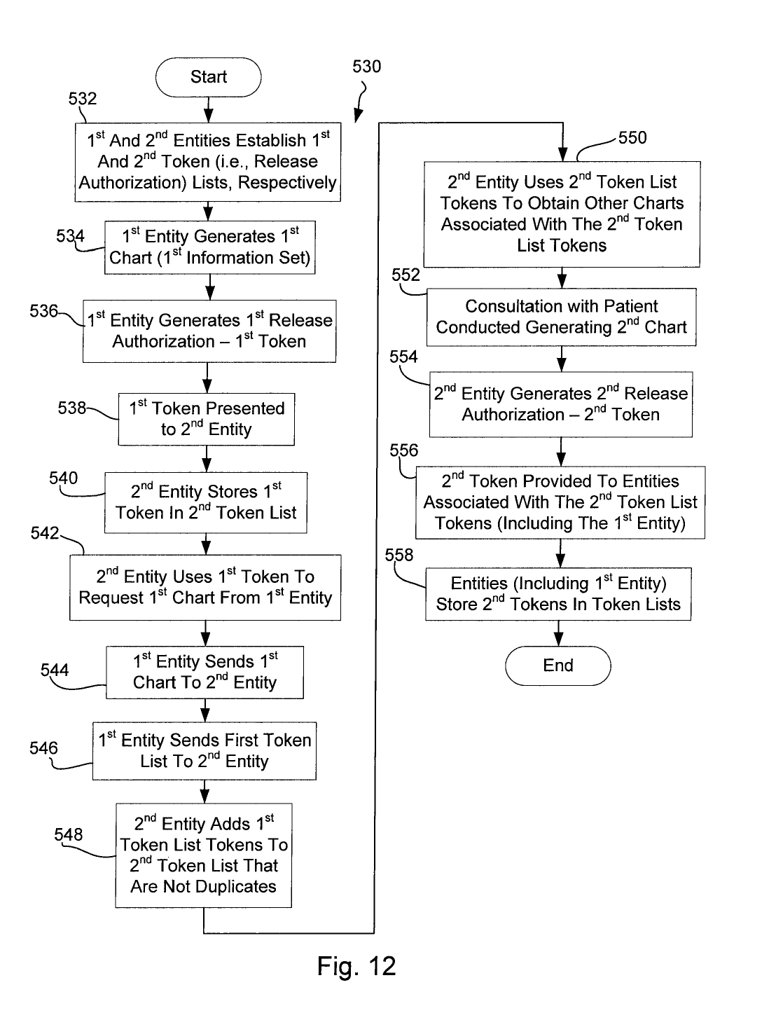

Referring again to FIG. 11, in addition to showing the three entities 500, 502 and 504, FIG. 11 also shows process steps in a sequence that are performed by each of the first, second and third entities according to at least one inventive method for facilitating the chart forwarding feature. In addition, reference is also made to FIG. 12 that shows a more conventional flow chart 530 that includes process blocks that are consistent with at least the first portion of the sequence shown in FIG. 11. To this end, in FIG. 12, at block 532, the first and second entities 500 and 502, respectively, in FIG. 11, establish first and second token lists, respectively. At block 534, the first entity (e.g., a computer used by a physician located at or associated with the first entity) generates a first chart or information set. At block 536, the first entity 500 generates a first release authorization which is also referred to herein as a first token.

Referring still to FIGS. 11 and 12, at block 538, the first token generated by the first entity is presented to the second entity. Here, presentation of the first token may take any of several different forms, including, but not limited to, electronic transmission of the first token to the second entity or manual presentation of the first token by a patient or a guardian (e.g., a parent) associated with the first chart. At block 540, the second entity 502 stores the first token in the second token list. At block 542, the second entity 502 uses the first token to request the first chart from the first entity. Here, the chart request would be performed in a manner similar to that described above. At block 544, the first entity, recognizing the first token as a valid and current token, sends or transmits the first chart to the second entity. In addition, at block 546, the first entity sends the first token list to the second entity. Initially, the first token list may include no tokens, and in that case, no tokens would be provided to the second entity at block 546.

Referring yet again to FIGS. 11 and 12, at block 548, second entity 502 adds tokens from the first token list that are not duplicates with currently existing tokens from the second list to the second token list. At block 550, second entity 502 uses the second token list tokens to obtain other charts associated with the second token list tokens. Here, obtaining the other charts includes using the other tokens to generate additional chart requests, transmitting the additional chart requests to other entities (e.g., a third entity, a fourth entity, etc.) that maintain the additional charts and receiving the additional charts from the other entities. At block 552, a physician uses the first chart and any additional charts that were obtained at block 550 during consultation with a patient and during or after that consultation generates a second chart or information set. At block 554, the second entity generates a second release authorization or second token associated with the second chart. Here, the second token may only be generated in some workflows/situations/scenarios when a patient requests that the second release authorization be generated. In the alternative, in at least some embodiments, the second token may be automatically generated for the first entity, for all of the entities associated with tokens on the second token list or for a subset of the entities associated with tokens on the second token list. Where the second token is only generated for a subset of the entities associated with the tokens on the second list, the subset may be determined based on configuration, security rules, administrative rules, relationship of the entities, only for entities the patient has previously authorized to share charts, etc. Herein, it will be assumed that the second entity is programmed to automatically generate second tokens for each of the entities associated with tokens on the second token list.

At block 556, the second entity provides the second token to each of the entities associated with the second token list tokens including, in the present example, the first entity. At block 558, all of the entities that receive the second token store that second token in their token lists. Thus, for example, when the first entity receives the second token at block 558, the first entity stores the second token in the first token list.

At this point, it should be appreciated that the second token list maintained by the second entity includes the first token associated with the first entity because of the activity at block 540. In addition, the first token list maintained by the first entity 500 includes the second token because of the activity that occurs at block 558. Thus, when a third entity 504 as shown in FIG. 11 is presented with either of the first or second tokens and uses that token to access either the first or second chart, the third entity will also be provided with the other of the first and second tokens which can then be used to obtain access to the other of the first and second charts.

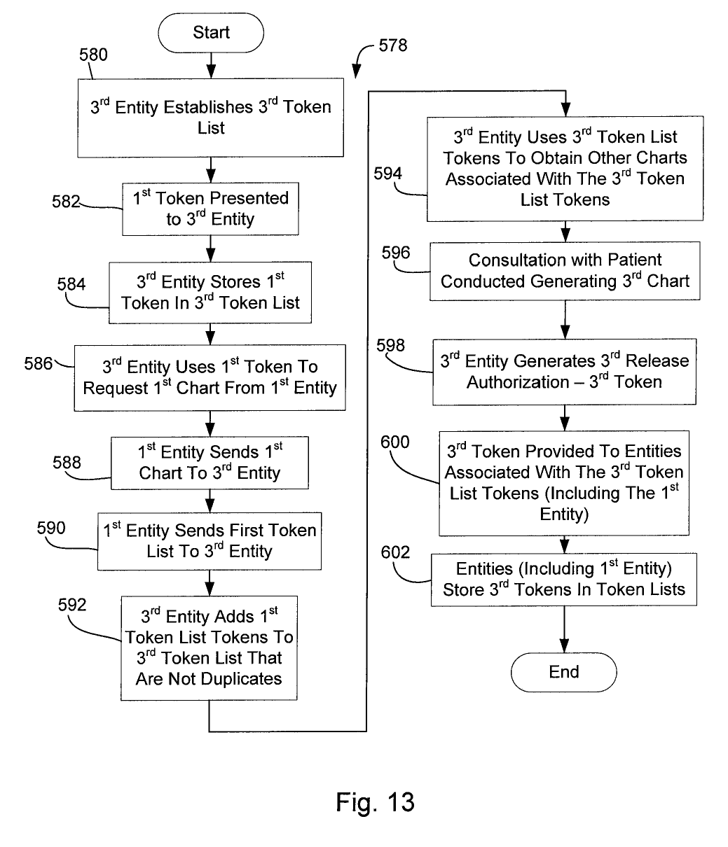

Referring now to FIG. 13, another method 578 is shown that is similar to the method shown in FIG. 12, albeit where a third entity uses a first token to access the first chart, receives the second token and then uses the second token to also access the second chart. FIG. 13 corresponds to the portion of the sequence in FIG. 11 including step 580 and steps below step 558. Referring to FIG. 13 and also again to FIG. 11, at block 580, the third entity 504 establishes a third token list. At block 582, the first token is presented to the third entity electronically, manually, or in some other fashion. At block 584, the third entity stores the first token in the third token list. At block 586, the third entity 504 uses a first token to request the first chart from the first entity. At block 588, the first entity sends the first chart to the third entity. In addition, at block 590, the first entity sends the first token list to the third entity. Here, because the first token list includes the second token due to the activity that occurred at block 558 in FIG. 12, the third entity receives the second token at block 590.

At block 592, third entity 504 adds the tokens from the first token list to the third token list so long as they are not duplicates. At block 594, the third entity 504 uses the tokens on the third token list tokens to obtain other charts associated with the third token list tokens. In this case, and because the third token list includes the second token, the third entity uses the second token to request the second chart at block 594 which is then provided to the third entity by the second entity 502. At block 596, a physician at the third entity uses all of the charts obtained at block 588 and block 594 during consultation with an associated patient and in at least some cases generates a third chart. It should be appreciated that by virtue of this method, a chart is always transmitted by the entity that creates and maintains that particular chart. This is in contrast to systems in which a second entity's chart may be obtained by establishing contact with a first entity and obtaining a local version of the second entity's chart that was previously stored by the first entity. In this way data integrity is maintained as charts are only received from the entities that maintain them thereby ensuring that the most up to date information is received by requesting entities.

When a third chart is generated, at block 598, the third entity generates a third release authorization or third token, in at least some cases. Once again, here, the third token may be automatically generated or may only be generated upon request by the patient. At block 600, the third token is provided to all of the entities associated with the third token list tokens. In the present example, at block 600, the third token would be provided to each of the first and second entities as each of those entities is associated with one of the tokens in the third token list. At block 602, each of the entities that receives the third token stores the third token in its own token list.

In at least some embodiments, when an entity is caused to provide a token associated with a chart maintained by the entity, the entity may be programmed to provide information related to all other tokens on the token list maintained by the entity. This process may, in some cases, alleviate the need for the list maintaining entity to transmit the token list subsequently. Here, however, it should be recognized that other entities could generate other charts between the time the token and token list are obtained by another entity and the time at which the charts are requested and a token list update process should still be performed at the time the chart request is performed to ensure all charts are obtained prior to consultation.

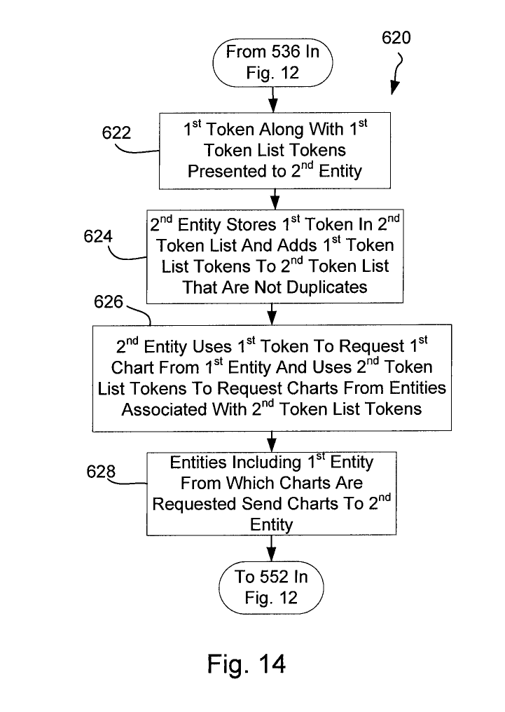

Referring now to FIG. 14, a sub-process 620 that may be substituted for a portion of the method described above with respect to FIG. 12 is illustrated wherein a token list is provided to an entity each time a token is provided. Referring also to FIG. 12, after the first entity 500 in FIG. 11 generates the first release authorization or first token at block 536, control may pass to block 622 in FIG. 14 where the first token along with the entire first token list tokens are presented to the second entity 502. Here, for example, the first entity may automatically transmit the first token and all of the tokens on the first token list to the second entity so that the second entity does not have to turn around and request additional tokens from the first entity. At block 624, the second entity stores the first token in the second token list and adds the first token list tokens to the second token list that are not duplicates. At block 626, the second entity uses the first token to request the first chart from the first entity and uses the second token list tokens to request charts from entities associated with the second token list tokens. At block 628, entities including the first entity from which the second entity requests charts sends the requested chart to the second entity. After block 628 in FIG. 14, control passes back to block 552 in FIG. 12 where the process shown in FIG. 12 continues.

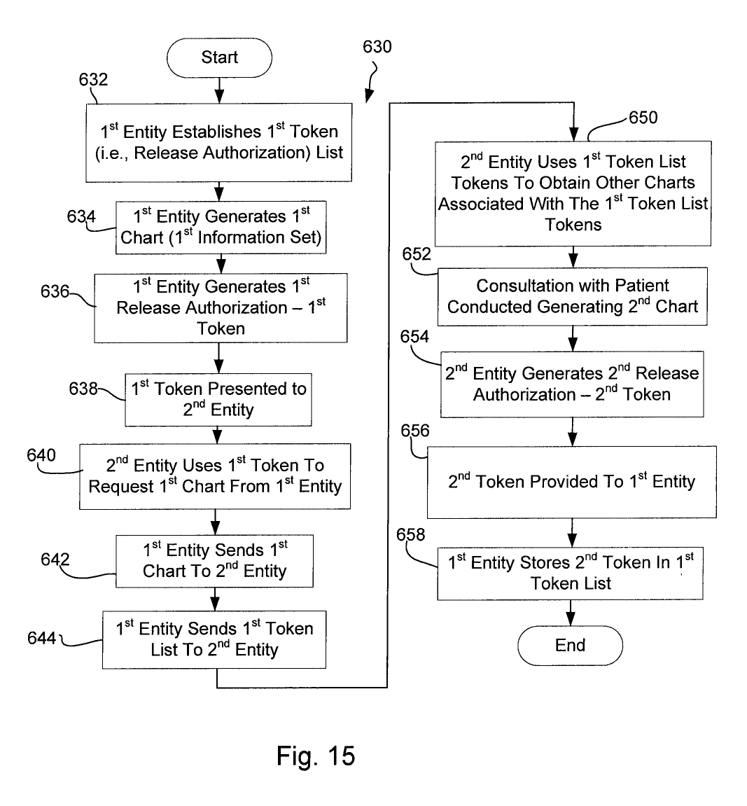

In at least some embodiments it is contemplated that, for each patient associated with a system, a single system entity may maintain the list of tokens corresponding to charts associated with the patient and that all other entities requesting charts for the patient will have to first access the entity maintaining the token list. For example, in at least some embodiments it is contemplated that a patient's primary care entity which is associated with the patient's primary care physician may maintain the token list for the patient and that all other entities will have to first contact the patient's primary care entity prior to obtaining all needed charts. In this regard, referring now to FIG. 15, another exemplary method 630 is shown wherein, at block 632, a first or primary care entity establishes a first token list. At block 634, the first entity generates a first chart and at block 636 the first entity generates a first token corresponding to the first chart. At block 638, the first token is presented to a second entity and at block 640 the second entity uses the first token to request the first chart from the first entity.

Referring still to FIG. 15, at block 642, the first entity sends the first chart to the second entity and at block 644 the first entity sends the first token list to the second entity. At block 650, the second entity uses the first token list tokens to obtain other charts associated with the first token list tokens. At block 652, a physician consults with the patient using the obtained charts and generates a second chart. At block 654, the second entity generates a second token usable to access the second chart which is provided only to the single first entity at block 656. At block 658, the first entity stores the second token in the first token list. Here, it is contemplated that only the first token is initially provided to other entities and that the other entities have to use the first token to first request access to the first chart from the first entity at which time the first entity provides the complete first token list to the other entity. Thus, when a third entity is presented the first token, the process described above with respect to FIG. 15 picks up at block 638 where the second entity in FIG. 15 is simply replaced by the third entity.

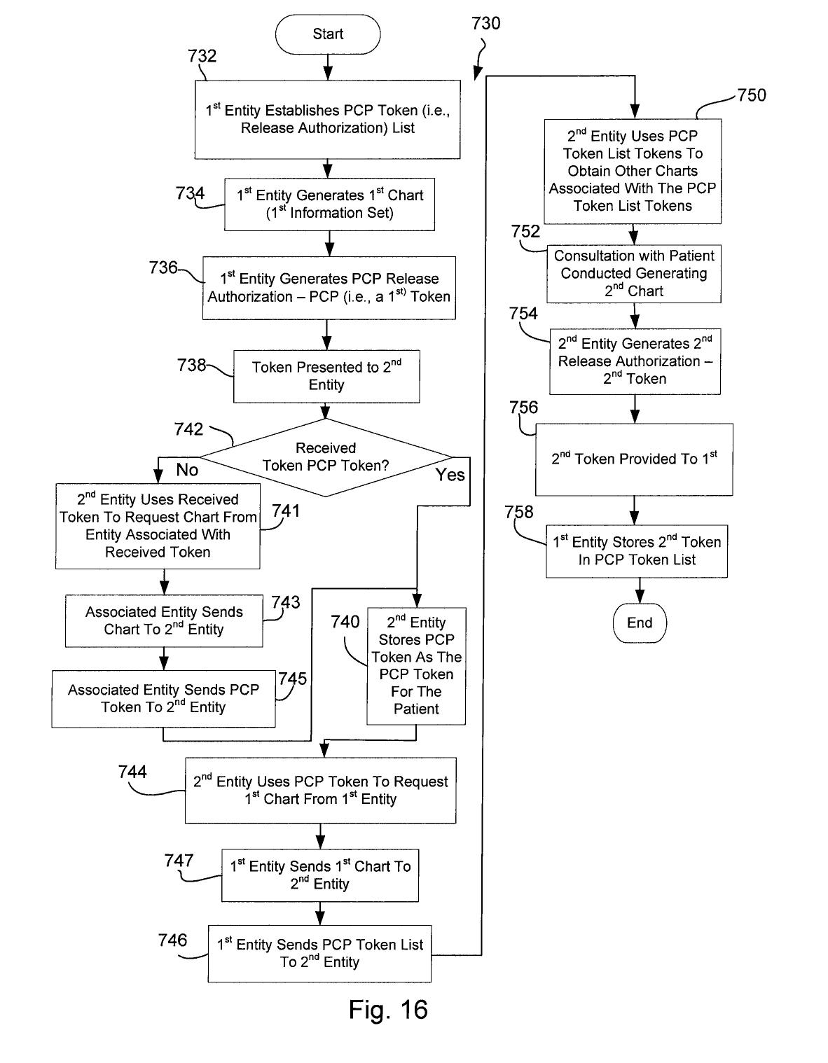

In still other embodiments, it is contemplated that, while a first or primary care entity may maintain a single list of RA tokens associated with a specific patient, any of the entities may be able to provide a token useable by other entities to gain access to the primary care token list through the other entity that provides the token. To this end, another inventive method 730 is shown in FIG. 16. At block 732, a first or primary care entity establishes a PCE token list for a patient. At block 734, the first entity generates a first chart and at block 736 the first entity generates a PCE or first token. At block 738, a token is presented to the second entity. Here, the presented token may be either the PCE token or a token that was issued by an entity other than the primary care entity.

At block 742, the second entity determines whether or not the received token is a PCE token. Where the token is a PCE token, control passes to block 740 where the second entity stores the PCE token as the PCE token for the patient after which control passes to block 744. Referring again to block 742, where the received token is not a PCE token, control passes to block 741 where the second entity uses the received token to request a chart from the entity associated with the received token. At block 743 the associated entity sends the requested chart to the second entity and at block 745, the associated entity sends the PCE token to the second entity. Here, it should be appreciated that, if an entity is not a primary care entity for a patient, rules governing the system would require that the entity always establish contact with the PCE entity prior to generating additional charts for the patient so that all entities generating charts for the patient would need to obtain and store the PCE token in a manner consistent with the method shown in FIG. 16. After block 745, control passes to block 740 where the received PCE token is stored by the second entity.

Continuing, at block 744, the second entity uses the PCE token to request a first chart from the first entity and at block 747 the first entity sends the first chart to the second entity. At block 746, the first entity sends the PCE token list to the second entity. At block 750, the second entity uses the PCE token list tokens to obtain other charts associated with the token list tokens. At block 752, a physician consults with the patient and generates a second chart. At block 754, the second entity generates a second token. At block 756, the second token is provided to the first entity and at block 758 the first entity stores the second token in the PCE token.

Although the technique for providing organizations the ability to allow for the convenient, secure, and expedient sharing of patient information between separate systems described herein is preferably implemented in software, it may be implemented in hardware, firmware, etc., and may be implemented by any other processor associated with an organization. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other machine accessible storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, a network such as the Internet, etc. (which are viewed as being the same as or interchangeable with providing such software via transportable storage medium).

1. A method for sharing related charts among entities comprising the steps of:
at a first entity:
creating a first chart associated with a first patient and a first release authorization (RA) token associated with the first chart;
maintaining a first token list including at least a second RA token associated with a second chart maintained by a second entity;
at a third entity:
receiving the first RA token;
using the first RA token to request the first chart from the first entity;
at the first entity:
receiving the request for the first chart;
rendering at least a portion of the first chart accessible to the third entity;
providing at least a portion of the first token list to the third entity; and
at the third entity:
receiving the portion of the first token list from the first entity; and
using the second RA token on the first token list to request the second chart from the second entity.

2. The method of claim 1 further including the step of, prior to providing at least a portion of the first token list, filtering the first token list to identify tokens to be provided to the third entity as a function of at least one of security rules, relationships of the entities and previous authorization.

3. The method of claim 1 further including the steps of, at the second entity, receiving the request for the second chart and rendering the second chart accessible to the third entity.

4. The method of claim 3 further including the steps of generating a third chart at the third entity, generating a third RA token at the third entity, presenting the third RA token to each of the first and the second entities and storing the third RA token in the first token list and in a second token list at the first and second entities, respectively.

5. The method of claim 4 further including the step of, at the third entity, maintaining a third token list for the first patient that includes each token received by the third entity.

6. The method of claim 4 further including the steps of, prior to presenting the third RA token, determining which entities to which to present the third RA token as a function of at least one of security rules, relationships of the entities and previous patient authorization.

7. The method of claim 1 further including the steps of, at the third entity, when the first token list is received, using each of the RA tokens on the first token list to request an associated chart and, at each entity that receives a request, rendering a chart accessible to the third entity.

8. The method of claim 7 further including the steps of generating a third chart at the third entity, generating a third RA token at the third entity, presenting the third RA token to each of the first and the second entities and storing the third RA token in the first token list and in a second token list at the first and second entities, respectively.

9. The method of claim 8 further including the step of, at the third entity, maintaining a third token list for the first patient that includes each token received by the third entity.

10. The method of claim 1 further including the steps of generating a third chart at the third entity, generating a third RA token at the third entity, presenting the third token to the first entity and storing the third token in the first token list at the first entity.

11. The method of claim 1 wherein the step of rendering the first chart accessible includes transmitting the first chart to the third entity and wherein the step of receiving the first RA token includes transmitting the first RA token to the third entity.

12. The method of claim 1 further including the steps of generating a third chart at the third entity, storing each RA token received at the third entity in a third token list and when a requesting entity requests the third chart from the third entity, providing the third token list to the requesting entity.

13. The method of claim 1 wherein each entity that receives a token associated with a chart maintained by another system entity stores the token in a token list and provides the token list to other entities that request an associated chart maintained by the entity.

14. The method of claim 1 wherein the first entity is a primary care entity for the first patient and wherein the second entity stores a primary care token associated with the first entity and the first patient and wherein, when the third entity uses the second RA token to request the second chart, the second entity provides the second chart and the primary care token to the third entity.

15. The method of claim 14 wherein, upon receiving the primary care token, the third entity contacts the primary care entity for the first patient and obtains the first chart and tokens for any other charts from the primary care entity.

16. A method for sharing charts associated with a first patient among system entities within a networked system wherein different entities maintain separate charts for the first patient, the method comprising the steps of:
at each of at least a subset of the entities and for the first patient:
when a chart is generated, generating a release authorization (RA) token for the chart;
maintaining an RA token list including all tokens received by the entity for the first patient from any other system entities;
when a token is received from another entity, using the received token to access a chart associated with the received token that is stored at another entity; and
when a requesting entity requests a chart associated with the first patient, providing the chart along with the RA token list associated with the first patient to the requesting entity.

17. The method of claim 16 further including the steps of, when a chart is generated by an entity, the token generated with the chart is provided to each of the entities associated with RA tokens in the RA token list maintained by the entity.

18. A system for sharing related charts among entities comprising:
first and third entities including processors that run programs to perform the steps of:
at the first entity:
creating a first chart associated with a first patient and a first release authorization (RA) token associated with the first chart;
maintaining a first token list including at least a second RA token associated with a second chart maintained by a second entity;
at a third entity:
receiving the first RA token;
using the first RA token to request the first chart from the first entity;
at the first entity:
receiving the request for the first chart;
rendering the first chart accessible to the third entity;
providing the first token list to the third entity; and
at the third entity:
receiving the first token list; and
using the second RA token on the first token list to request the second chart from the second entity.

19. The system of claim 18 wherein the second entity includes a processor that runs programs to perform the steps of receiving the request for the second chart and rendering the second chart accessible to the third entity.

20. The system of claim 19 wherein the third entity processor is further programmed to generate a third chart at the third entity, generate a third RA token at the third entity and present the third RA token to each of the first and the second entities and wherein the first and second entity processor are further programmed to store the third RA token in the first token list and in a second token list at the first and second entities, respectively.

21. The system of claim 20 wherein the third entity processor is further programmed to maintain a third token list for the first patient that includes each token received by the third entity.

22. The system of claim 18 wherein the third entity processor is further programmed to, when the first token list is received, use each of the RA tokens on the first token list to request an associated chart.

23. The system of claim 18 wherein the first entity renders the first chart accessible by transmitting the first chart to the third entity.

24. A method for sharing charts associated with a first patient among system entities within a networked system wherein different entities maintain different charts for the first patient, the method comprising the steps of:
at each of at least a subset of the entities and for the first patient:
when a chart is generated, generating a release authorization (RA) token for the chart;
maintaining an RA token list including all of the tokens received for the first patient from any other system entities;
when the generated RA token is presented to a receiving entity, presenting at least a subset of the other tokens from the token list to the receiving entity; and
when the entity receives a token, using each received token to obtain an associated chart stored by another entity.
